(19) United States
(12) Patent Application Publication
(10) Pub. No.: US 2007/0086288 A1
(43) Pub. Date: Apr. 19, 2007

(54) OPTICAL PICKUP APPARATUS EQUIPPED WITH OPTICAL SYSTEM CORRECTING SPHERICAL ABERRATION, AND INFORMATION RECORDING AND REPRODUCTION APPARATUS USING THE SAME

(75) Inventor: SHINNOSUKE TORII, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/548,504

(22) Filed: Oct. 11, 2006

(30) Foreign Application Priority Data
Oct. 19, 2005 (JP) 2005-304468

(51) Int. Cl. G11B 7/00; G11B 7/135

(52) U.S. Cl. 369/44.23; 369/112.28

(57) ABSTRACT

The present invention provides an optical pickup apparatus which can prevent an offset to a focus signal and can satisfactorily correct spherical aberration generated by difference in substrate thickness while achieving the formation of a thinner type of the apparatus. In the present invention, a parallel flat plate for correcting spherical aberration generated by difference in thickness of a transmissive substrate to the first and second recording layers of an optical disk is arranged between a beam splitter and a collimator, and in addition, the spherical aberration is corrected by inserting and removing the parallel flat plate, or switching and inserting another parallel flat plate having a different thickness to an optical path.

### BACKGROUND OF THE INVENTION

1. Field of the Invention

The present invention relates to an optical pickup apparatus which records or reproduces an information signal on or from a recording media such as an optical disk, in particular, an optical pick-up apparatus equipped with a parallel flat plate for spherical aberration correction, and to an information recording and reproduction apparatus including the optical pickup.

2. Description of the Related Art

In recent years, in optical disks such as a DVD and a BD, so as to increase a recording capacity thereof, development of the formation of a multilayer which has a plurality of recording layers in the same disk has been performed. Actually, commercial production of double-layer disks having the first and second recording layers has been achieved.

Nevertheless, in the double-layer disks, there was a problem that, since the thicknesses of a transmissive substrate up to the first and second recording layers were different, respectively, spherical aberration was generated when the same optical system was used, and hence, information quality deteriorated.

Technology which corrects the spherical aberration generated by such difference in substrate thickness is disclosed by, for example, Japanese Patent Application Laid-Open No. H05-241095 or Japanese Patent Application Laid-Open No. 2000-331367.

First, technology disclosed by Japanese Patent Application Laid-Open No. H05-241095 will be explained simply. In an apparatus of this application, a light beam emitted from a light source 5 is reflected on a half-mirror 6, is introduced by a collimator lens 2 to an objective lens 3, and is focused on an optical disk 4.

In addition, the reflected light from the optical disk 4 permeates the objective lens 3, collimator lens 2, and half-mirror 6, and is introduced into a light-receiving device 7. Here, spherical aberration by difference in substrate thickness of the optical disk 4 is corrected by thickness of a parallel flat plate (corrector plate) 1.

Next, technology disclosed by Japanese Patent Application Laid-Open No. 2000-331367 will be explained simply. An apparatus of this application is designed so as to form an optimum beam spot without a parallel flat plate 3-1 when using a disk 4-1 with substrate thickness A. Then, when a disk 4-2 with substrate thickness (A-B) is used, spherical aberration is corrected by inserting the parallel flat plate 3-1, which has thickness B and the same refractive index as a refractive index of a disk substrate, between the objective lens 1 and disk 4-2.

Both technologies mentioned above utilize spherical aberration generated by arranging a parallel flat plate orthogonally to an optical axis in divergent light or converging light, and correct spherical aberration generated by the difference in substrate thickness of a disk.

In the technology disclosed by Japanese Patent Application Laid-Open No. H05-241095, the parallel flat plate 1 is arranged only in an approach route between the half-mirror 6 and light source 5. In such a constitution, defocus is generated on the approach route by the inserted parallel flat plate 1. However, since the parallel flat plate 1 is not inserted on a return route, light is focused on the light-receiving device 7 from the collimator lens 2 with defocus being generated.

For this reason, since the light is not focused accurately on a light-receiving surface of the light-receiving device 7, an offset arises in a focus signal which is obtained by, for example, an astigmatism method or a knife edge method. Although a method of moving the light-receiving device 7 according to the defocus is also proposed to this problem, it is expected that it is difficult to achieve positional accuracy accompanying movement of the light-receiving device 7.

In addition, in the technology disclosed by Japanese Patent Application Laid-Open No. 2000-331367, a mechanism which inserts and removes a parallel flat plate is arranged between an objective lens and a disk surface. For this reason, it becomes difficult to achieve the formation of a thinner type of a recording and reproduction apparatus using an optical disk, which is particularly demanded in recent years. In addition, recently, with a raise in numerical aperture of an objective lens, a working distance has been decreasing and it becomes difficult to actually achieve this mechanism.

### SUMMARY OF THE INVENTION

The object of the present invention is to provide an optical pick-up apparatus which can prevent an offset to a focus signal and can satisfactorily correct spherical aberration generated by difference in substrate thickness with achieving formation of a thinner type of the apparatus; and an information recording and reproduction apparatus.

In order to solve the above-mentioned tasks, the optical pickup apparatus of the present invention includes: a light source; a collimator for converting an emitted light from the light source to a parallel beam; an objective lens for focusing the parallel light beam on each of the recording layers of a recording medium; a beam splitter arranged between the light source and the collimator; a light-receiving device for receiving a light reflected from the recording medium and split by the beam splitter; a parallel flat plate which is arranged between the beam splitter and the collimator so as to correct spherical aberration generated by difference in thickness of a transmissive substrate with respect to each of the recording layers of the recording medium; and a driving mechanism for inserting and removing the parallel flat plate to the optical path, or switching and inserting another parallel flat plate having a different thickness to the optical path.

In addition, the information recording and reproduction apparatus of the present invention includes the above-mentioned optical pickup apparatus.

Further features of the present invention will become apparent from the following description of exemplary embodiments with reference to the attached drawings.

### BRIEF DESCRIPTION OF THE DRAWINGS

FIGS. 1A and 1B are structural diagrams showing a first embodiment of an optical pickup apparatus of the present invention.

FIG. 2 is a graph showing a relation of difference in thickness of a transmissive substrate (layer) of an optical disk versus the thickness of the parallel flat plate 5 for correcting spherical aberration generated by the difference in thickness of the substrate.

FIGS. 3A and 3B are diagrams for explaining the presence or absence of a focus offset in the case where the parallel flat plate is arranged between a PBS 3 and a collimator lens 6 and the case where the parallel flat plate is arranged between a semiconductor laser 1 and the PBS 3.

FIGS. 4A and 4B are structural diagrams showing a second embodiment of an optical pickup apparatus of the present invention.

FIG. 5 is a block diagram showing an embodiment of an information recording and reproduction apparatus of the present invention.

### DESCRIPTION OF THE EMBODIMENTS

Next, the best modes for carrying out the present invention will be described in detail referring to drawings.

FIG. 5 is a block diagram showing an embodiment of an information recording and reproduction apparatus according to the present invention. Reference numeral 9 denotes an optical disk which performs the recording and reproduction of information. Reference numeral 102 denotes a spindle motor which mounts and rotates the optical disk 9. Reference numeral 103 denotes a spindle motor driver. Reference numeral 8 denotes an objective lens for light beam radiation from the semiconductor laser 1 and formation of spot on a recording surface of the optical disk 9. Reference numeral 105 denotes an objective lens actuator which drives the objective lens 8 in two axis directions of a vertical direction and a horizontal direction with respect to a disk surface so as to focus a light spot (hereinafter, referred to as “focusing” or “Fo”) on the recording surface following the axial runout of the optical disk 9 and the like, and to make the light spot follow a track arranged on the optical disk 9 (hereinafter, referred to as “tracking” or “Tr”). Reference numeral 112 denotes a laser driver which controls a light amount of the semiconductor laser. Reference numeral 106 denotes an optical pickup apparatus including the objective lens 8, semiconductor laser 1, objective lens actuator 105, laser driver 112, optical elements and sensor which are mentioned later, and the like. Reference numeral 108 denotes an optical pickup driver which controls the objective lens actuator 105, laser driver 112, and the like. Reference numeral 109 denotes a seek motor for conveying the optical pickup apparatus 106 in a radial direction of the optical disk 9. Reference numeral 110 denotes a seek motor driver which controls the seek motor 109. Reference numeral 111 denotes a controller which is constructed of a CPU, memory, and the like so as to perform servo/RF processing such as the control of each driver and the processing of an output signal from a sensor provided in the optical pickup apparatus 106, and perform integrated control of the optical disk apparatus 101 to bear a core of each sequence control.

Next, an operation of the information recording and reproduction apparatus 101 in FIG. 5 will be explained in detail.

The controller 111 of the information recording and reproduction apparatus 101 performs the integrated control of the optical pickup driver 108, seek motor driver 110, and spindle motor driver 103, and rotates the spindle motor 102 at a desired revolution speed through the spindle motor driver 103. Thereby, the optical disk 9 mounted on the spindle motor 102 is also integrally rotated. In addition, the seek motor 109 which is a stepping motor is driven by the seek motor driver 110, and the optical pickup apparatus 106 is conveyed in an arbitrary position in a radial direction of the optical disk 9. In addition, by the laser driver 112, laser light from the semiconductor laser 1 is controlled, and is radiated on the recording surface of the optical disk 9 through the objective lens 8, whereby the recording and reproduction of information are executed.

At this time, in order to make the objective lens 8 follow a track arranged on the recording surface of the optical disk 9 as described above, a drive current (an Fo current in an Fo direction, and Tr current in a Tr direction) to the objective lens actuator 105 is controlled on the basis of an Fo error signal and a Tr error signal, which are later mentioned, by the optical pickup driver 108. In addition, the Fo error signal is a signal obtained according to a vertical relative distance between the objective lens 8 and optical disk 9, and it is a signal becoming 0 in a focused state, for example, can be obtained by an astigmatism method. On the other hand, the Tr error signal is a signal obtained according to a relative position between a track formed on a recording surface of the optical disk 9 and a spot in a direction parallel to the disk surface, and it is a signal becoming 0 when the spot is located in an approximate center of a track, for example, can be obtained by a push-pull method or a differential push-pull method. In addition, since a generation method and structure of the above-mentioned Fo error signal and Tr error signal are well known, their explanation is omitted. In addition, the present invention is applicable also in methods other than the astigmatism method and differential push-pull method which are mentioned above.

First Embodiment

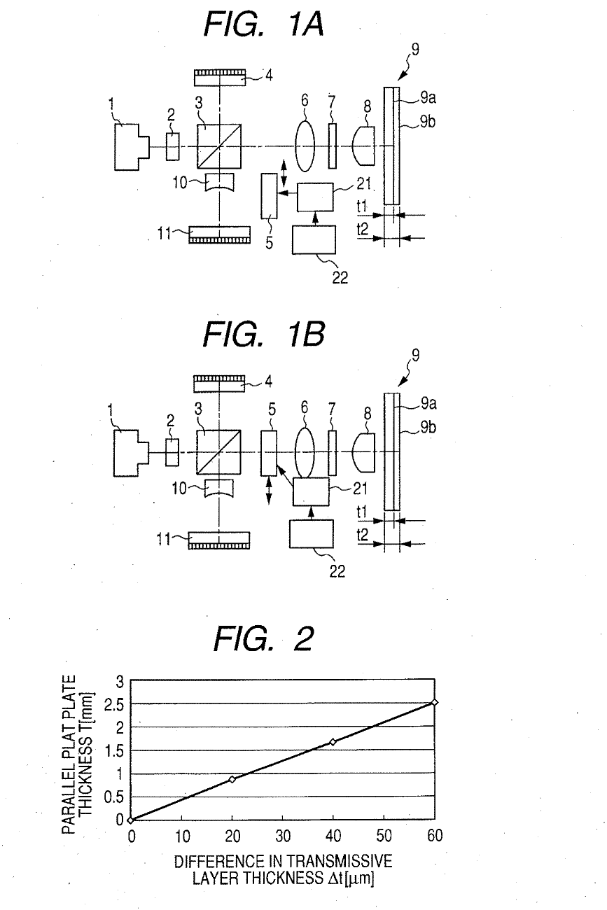

FIGS. 1A and 1B are structural diagrams showing a first embodiment of an optical pickup apparatus of the present invention which are shown in FIG. 5. FIG. 1A shows a structure in the case of focusing light into a light spot onto a first information recording layer of an optical disk as mentioned later, and FIG. 1B shows a structure in the case of focusing light onto a second information recording layer.

An emitted beam from the semiconductor laser 1 which is a light source is split into a main beam and two subbeams by a diffractive grating 2. These subbeams are used for servo signal generation for DPP (differential push-pull).

As for the beam from the diffractive grating 2, its part is reflected by PBS (Polarization Beam Splitter) 3 to be made incident into the PD (photodetector) 4 for monitoring. An output of this PD 4 for monitoring is used for control of an emission power from the semiconductor laser 1.

The beam which permeates the PBS 3 is converted to a parallel beam by the collimator lens 6, and is further incident into the objective lens 8 through a λ/4 plate 7. This incident light is focused by the objective lens 8 and is imaged on an information recording layer through a transmissive substrate (hereinafter, also referred to as “transmissive layer”) of the optical disk 9. The optical disk 9 is composed of a first information recording layer 9a having a transmissive layer (transmissive substrate) with a thickness of t1, and a second information recording layer 9b having a transmissive layer with a thickness of t2.

The beam reflected from the optical disk 9 is focused by the objective lens 8 to be made incident into the PBS 3 through the λ/4 plate 7 and collimator lens 6. This incident light is reflected by the PBS 3 to be focused by the sensor lens 10 on the PD 11 for RF servo. An information signal and a signal for servo are obtained with an output from this PD 11 for RF servo.

Here, a wavelength of the semiconductor laser 1 is about 660 nm, numerical aperture of the objective lens 8 is 0.65, and a focal length is 1.85 mm.

In addition, the parallel flat plate 5 is arranged so as to be able to insert and remove in a direction orthogonal to an optical axis between the PBS 3 and collimator lens 6 as shown by an arrow in FIGS. 1A and 1B. In the case of inserting or removing the parallel flat plate 5 to or from the optical axis, the parallel flat plate 5 is driven in a direction orthogonal to the optical axis using a driving mechanism constructed of a drive source 22 such as a stepping motor and a solenoid, and a transfer mechanism 21 such as a gear.

Here, a method in the case of focusing light into a light spot on each of the first information recording layer 9a and second information recording layer 9b of the optical disk 9 will be explained.

This embodiment is designed so that a light beam from the semiconductor laser 1 may be optimally focused to a light spot onto the first information recording layer 9a of the optical disk 9 in the optical system in which the parallel flat plate 5 is removed from the optical path as shown in FIG. 1A.

Table 1 shows design values of a projection system at the time of removing the parallel flat plate 5 in this embodiment from the optical axis. In addition, an aspherical shape is expressed in Formula 1 and is listed in Table 2, wherein an optical axis direction is X, a height in a direction vertical to the optical axis is h, and a conical coefficient is k.

$$X = \frac{{h}^{2} / r}{1 + \sqrt{1 - ( 1 + k ) {h}^{2} / {r}^{2}}} + {Bh}^{4} + {Ch}^{6} + {Dh}^{8} + {Eh}^{10} + {Fh}^{12} + {Gh}^{14} \qquad Formula 1$$

TABLE 1

| | Remarks | R | d | N |
|---|---|---|---|---|
| 1 | LD | ∞ | 0.58 | |
| 2 | | ∞ | 0.25 | 1.51374 |
| 3 | | ∞ | 1 | |
| 4 | Diffractive | ∞ | 1 | 1.506512 |
| 5 | grating | ∞ | 1.25 | |
| 6 | PBS | ∞ | 3 | 1.51374 |
| 7 | | ∞ | 5.89 | |
| 8 | Collimator | 37.78794 | 1.86 | 1.506512 |
| (Asphere 1) | | | | |
| 9 | | −7.12334 | 1 | |
| (Asphere 2) | | | | |
| 10 | QWP | ∞ | 1 | 1.51374 |
| 11 | | ∞ | 5 | |
| 12 | Objective | 1.25492 | 1 | 1.609045 |
| (Asphere 3) | lens | | | |
| 13 | | −7.7037 | 0.917548 | |
| (Asphere 4) | | | | |
| 14 | Transparent | ∞ | 0.57 | 1.578961 |
| 15 | substrate | ∞ | 0 | |

TABLE 2

| | Asphere 1 | Asphere 2 | Asphere 3 | Asphere 4 |
|---|---|---|---|---|
| K | −3.14817E+03 | 3.49641 | −8.85630E−01 | −1.53824E+02 |
| B | 2.76000E−03 | 8.50000E−04 | 2.93100E−02 | 1.62500E−02 |
| C | −2.10000E−04 | 3.60000E−04 | 3.84000E−03 | −1.64000E−03 |
| D | −1.20000E−04 | −3.14459E−05 | 1.82000E−03 | −1.86000E−03 |
| E | −1.05737E−05 | 1.99354E−05 | 5.00000E−04 | −4.10000E−04 |
| F | 1.17426E−05 | −1.08375E−05 | −3.90000E−04 | 4.80000E−04 |
| G | 1.79017E−06 | −4.48270E−07 | 0 | 0 |

Here, since difference of t2−t1=Δt in transmissive layer thickness arises as being in an optical system shown in FIG. 1A in the case of focusing light to a light spot on the second information recording layer 9b, spherical aberration is generated.

Then, in the optical system of this embodiment, as shown in FIG. 1B, spherical aberration is corrected by inserting the parallel flat plate 5 between the PBS 3 and the collimator lens 6 by driving of a driving mechanism. In addition, in this embodiment, the parallel flat plate 5 having a refractive index N=1.827 is used.

FIG. 2 shows a relation of the difference Δt in thickness of the transmissive layer versus the thickness T of the parallel flat plate 5 for correcting the spherical aberration generated by the difference Δt in thickness of the transmissive layer. The thickness of the parallel flat plate 5 per 1 μm of the difference in thickness of the transmissive layer is about 42.1 μm from FIG. 2. Consequently, for example, in the case that difference Δt in transmissive layer thickness is 60 μm, it turns out that it is effective to insert the parallel flat plate 5 having a thickness of about 2.5 mm.

Table 3 shows design values of a projection system at the time of inserting the parallel flat plate 5. In addition, in Table 3, optical components other than the parallel flat plate 5 are the same as those of Table 1.

TABLE 3

| | Remarks | R | d | N |
|---|---|---|---|---|
| 1 | LD | ∞ | 0.58 | |
| 2 | | ∞ | 0.25 | 1.51374 |
| 3 | | ∞ | 1 | |
| 4 | Diffractive | ∞ | 1 | 1.506512 |
| 5 | grating | ∞ | 1.25 | |
| 6 | PBS | ∞ | 3 | 1.51374 |
| 7 | | ∞ | 1.89 | |
| 8 | Parallel | ∞ | 2.5 | 1.827079 |
| 9 | flat plate | ∞ | 1.5 | |
| 10 | Collimator | 37.78794 | 1.86 | 1.506512 |
| (Asphere 1) | | | | |
| 11 | | −7.12334 | 1 | |
| (Asphere 2) | | | | |
| 12 | QWP | ∞ | 1 | 1.51374 |
| 13 | | ∞ | 5 | |
| 14 | Objective | 1.25492 | 1 | 1.609045 |
| (Asphere 3) | lens | | | |
| 15 | | −7.7037 | 0.906379 | |
| (Asphere 4) | | | | |
| 16 | Transparent | ∞ | 0.63 | 1.578961 |
| 17 | substrate | ∞ | 0 | |

In this way, it becomes possible to correct the spherical aberration generated due to the difference in thickness of the transmission layer by removing the parallel flat plate 5 from the optical path when recording or reproducing information to or from the first information recording layer 9a of the optical disk 9, and by inserting the parallel flat plate 5 into the optical path when recording or reproducing information to or from the second information recording layer 9b.

In addition, since the parallel flat plate 5 is arranged between the beam splitter 3 and the collimator lens 6, the thickness of an optical pickup apparatus main body does not increase. That is, when a parallel flat plate is arranged between an objective lens and a disk like the above-described Japanese Patent Application Laid-Open No. 2000-331367, the thickness of an optical pick-up apparatus increases and fails in miniaturization of the apparatus, but the present invention can meet the demand of the miniaturization in recent years.

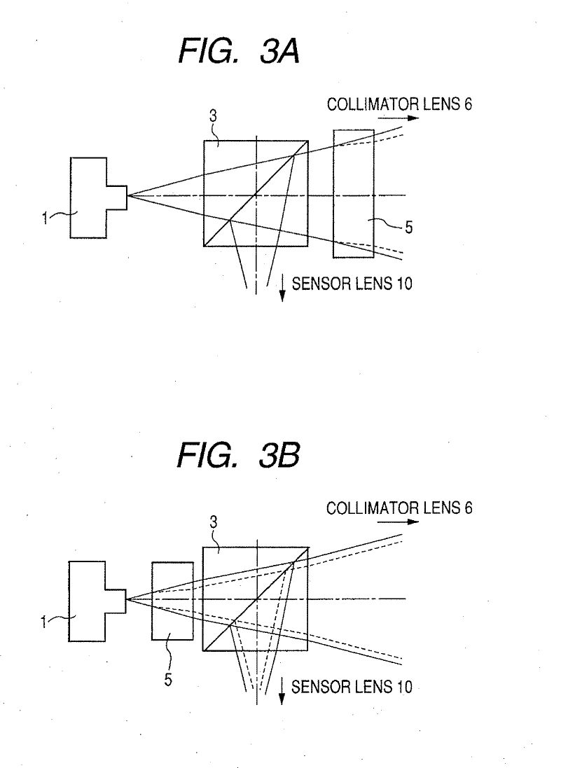

FIG. 3A is a schematic diagram in the case of arranging the parallel flat plate 5 between the PBS 3 and the collimator lens 6 like this embodiment, and FIG. 3B is a schematic diagram in the case of arranging the parallel flat plate 5 between the semiconductor laser 1 and the PBS 3. Referring to FIGS. 3A and 3B, difference in the case of the parallel flat plate 5 arranged between the PBS 3 and collimator lens 6 as well as the case of the parallel flat plate 5 arranged between the semiconductor laser 1 and the PBS 3 will be explained in detail.

In FIGS. 3A and 3B, a part of optical components such as the diffraction grating 2 is omitted for simplification. In addition, in FIGS. 3A and 3B, a solid line shows laser light at the time of removing the parallel flat plate 5 from the optical path, and a broken line shows laser light at the time of inserting the parallel flat plate 5 to the optical path.

In this embodiment, as shown in FIG. 3A, in both of an approach route and a return route, laser light permeates the parallel flat plate 5. For this reason, it turns out that, in the return route, the laser light after permeating the parallel flat plate 5 draws the same locus regardless of the presence of the parallel flat plate 5.

On the other hand, in the case of FIG. 3B, since only the laser light on the approach route permeates the parallel flat plate 5, loci of the approach route and return route after permeating the parallel flat plate 5 by the presence of the parallel flat plate 5 change, and defocus can be confirmed.

In addition, in the design values of the optical system of this embodiment which are shown in Table 3, the defocus of the collimator lens 6 between the cases of inserting and removing the parallel flat plate 5 is about 1.13 mm.

In this way, in the case of FIG. 3B, an offset is generated in an optical axis direction with respect to the light-receiving device 11 in arrangement of an ideal optical system. When the offset is generated, a focus offset arises in the focus error signal to be obtained by a general astigmatism method, a knife edge method or the like as a focus servo method of the objective lens 8, and hence, an accurate recording and reproduction operation becomes difficult. Explanation of the astigmatism method and the knife edge method is omitted since they are known.

On the other hand, in this embodiment, since the focus offset is not generated as shown in FIG. 3A, a satisfactory recording and reproduction operations can be performed.

Second Embodiment

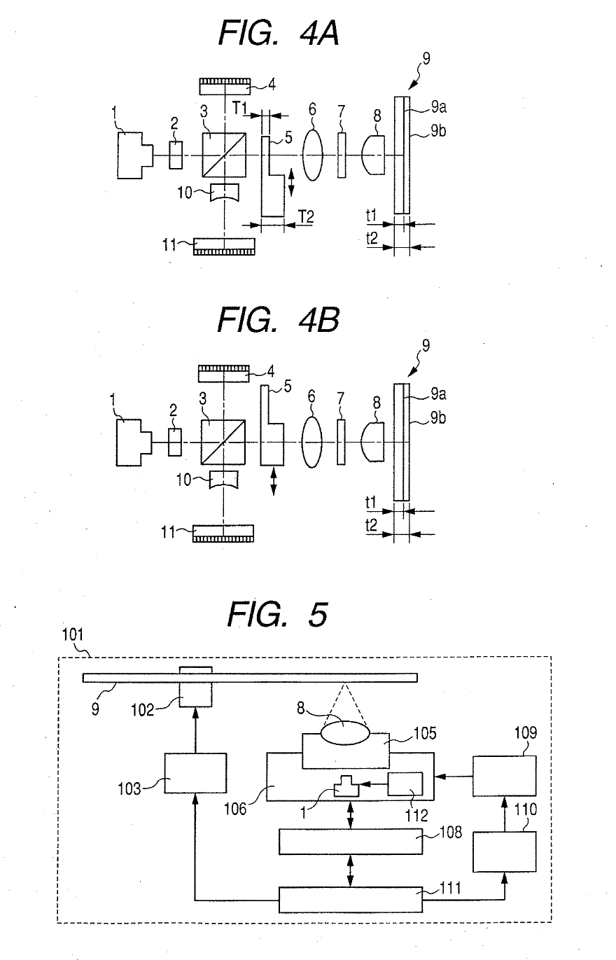

FIGS. 4A and 4B are structural diagrams showing the second embodiment of an optical pickup apparatus of the present invention. In addition, the basic structure of this embodiment is the same as that in FIGS. 1A and 1B, and the same reference numerals are applied to the same parts as those in FIGS. 1A and 1B, and explanation thereof is omitted. In this embodiment, spherical aberration is corrected by switching and inserting another parallel flat plate having a different thickness to an optical path. Therefore, a parallel flat plate 5 which is a stepwise plate having two thicknesses of T1 and T2, that is, a thick part and a thin part is used to be switched and inserted to the optical path.

In the case of focusing light on the first information recording layer 9a of the optical disk 9, as shown in FIG. 4A, the substrate having a thickness T1 part of the parallel flat plate 5 is inserted orthogonally to the optical axis. At that time, an optical system is designed so that light may be focused to an optimum spot on the first information recording layer 9a.

In addition, in the case of light being focused on the second information recording layer 9b similarly to the first embodiment, spherical aberration is generated by the difference Δt in thickness of the transmissive layer. For this reason, in this embodiment, when focusing light on the second information recording layer 9b , as shown in FIG. 4B, the parallel flat plate 5 is moved in an upper direction of the drawing by driving of a driving mechanism (not shown), and a part of the parallel flat plate 5 having a plate thickness T2 is inserted between the PBS 3 and the collimator lens 6. By doing so, the spherical aberration generated by the difference Δt in thickness of the transmissive layer is corrected.

Furthermore, it is possible to design a plate thickness T2 of the parallel flat plate 5 as T2=T1+T by setting the plate thickness T of the parallel flat plate of the vertical axis shown in FIG. 2 as a variation from the plate thickness T1.

Thus, when the plate thickness T1 of the parallel flat plate 5 is set to be 0.5 mm in a state of FIG. 4A and the difference Δt in thickness in the transmissive layer is 60 μm, from FIG. 2, T2 becomes T2=0.5+2.5=3 mm.

Also in this embodiment, while being able to correct the spherical aberration generated by the difference Δt in thickness of the transmissive layer similarly to the first embodiment, the thickness of an optical pickup apparatus does not increase. In addition, the present invention is not limited only to the specific examples shown in the above embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-304468, filed Oct. 19, 2005, which is hereby incorporated by reference herein in its entirety.

What is claimed is:

1. An optical pickup apparatus comprising:
a light source;
a collimator for converting an emitted light from the light source to a parallel light beam;
an objective lens for focusing the parallel light beam on each of the recording layers of a recording medium;
a beam splitter arranged between the light source and the collimator;
a light-receiving device for receiving a light reflected from the recording medium and split by the beam splitter;
a parallel flat plate which is arranged between the beam splitter and the collimator so as to correct spherical aberration generated by difference in thickness of a transmissive substrate with respect to each of the recording layers of the recording medium; and
a driving mechanism for inserting and removing the parallel flat plate to the optical path, or switching and inserting another parallel flat plate having a different thickness to the optical path.

2. The optical pick-up apparatus according to claim 1, wherein the recording medium has two recording layers.

3. An information recording and reproduction apparatus comprising:
a spindle motor for rotating a recording medium having a plurality of recording layers; and
an optical pickup apparatus for optically recording and reproducing information with respect to the recording medium,
wherein the optical pickup apparatus comprising:
a light source;
a collimator for converting an emitted light from the light source to a parallel light beam;
an objective lens for focusing the parallel light beam on each of the recording layers of a recording medium;
a beam splitter arranged between the light source and the collimator;
a light-receiving device for receiving a light reflected from the recording medium and split by the beam splitter;
a parallel flat plate which is arranged between the beam splitter and the collimator so as to correct spherical aberration generated by difference in thickness of a transmissive substrate with respect to each of the recording layers of the recording medium; and
a driving mechanism for inserting and removing the parallel flat plate to the optical path, or switching and inserting another parallel flat plate having a different thickness to the optical path.
